(19) United States
(12) Patent Application Publication
(10) Pub. No.: US 2011/0139010 A1
(43) Pub. Date: Jun. 16, 2011

(54) Oil Separator

(76) Inventors: Thorsten Sattler-Laegel, Leutenbach-Nellmersbach (DE); Christian Schuerle, Neu-Ulm (DE); Dieter Grafl, Ulm (DE)

(21) Appl. No.: 11/792,652

(22) PCT Filed: Aug. 4, 2006
(86) PCT No.: PCT/EP2006/007744

§ 371 Date: Oct. 25, 2007

(30) Foreign Application Priority Data
Aug. 12, 2005 (DE) 10 2005 038 257.6

(51) Int. Cl. B01D 19/00

(52) U.S. Cl. 96/156; 96/188; 96/190; 96/194; 210/188

(57) ABSTRACT

The present invention relates to an oil separator for separating oil and/or oil mist from a gas. An optimum separation performance is hereby achieved with normal volume flow of the gas (A) but also in the case of an increased volume flow (A) or a blockage of the oil separator, the ventilation for example of a crankcase is ensured and observance of a maximum pressure loss is ensured. For this purpose, two oil separation elements (10a to 10d and 10e to 10h) are disposed one behind the other in the volume flow (A), the spacing of which from each other is variable.

The present invention relates to an oil separator for separating oil and/or oil mist from a gas. For this purpose, labyrinths or metal meshes or in particular cyclones, which are current according to the state of the art, are used. Oil or oil mist separators of this type are used in particular in order to separate oil or oil mist from crankcase gases, also termed blowby gases. For this purpose, the blowby gas is guided through the oil separator and subsequently re-supplied in purified form to the inlet manifold of an internal combustion engine.

The design of an oil separator of this type is usually effected for a nominal volume flow (blowby) of the gas which occurs in normal operation of the engine taking into account the pressure conditions in the crankcase. If the volume flow is known, then, assuming a maximum permissible pressure loss between the pressure side and the suction side of the oil separator (i.e. in front of the oil separator and after the oil separator), the oil separator can be designed such that it displays a maximum separation performance under these conditions.

However under specific conditions in engines, also considerably higher volume flows can occur. Hence it is generally required that the oil separation system ensures both a certain separation performance and the function of crankcase ventilation up to a multiple of this nominal volume flow as a safety measure. In particular, the pressure drop across the oil separator must not become too great even in the case of such an increased volume flow in order not to impede the crankcase ventilation. Hence, non-adaptive oil separators are designed for the maximum volume flow, which has the disadvantage however that they then cannot achieve optimum separation levels or separation performance with the nominal volume flow. This means that the separation performance is no longer optimal with a nominal volume flow.

Furthermore, over the lifespan of an oil separator, the latter can also become soiled and partially or entirely blocked. In the case of icing, blockages normally occur temporarily. In this case, the maximum permitted pressure loss is then already exceeded in the case of significantly smaller volume flows, for example already within the normal operating area. The minimum function of the total system, namely the ventilation of the crankcase, is endangered in this case with non-adaptive oil separation systems.

In the state of the art, various methods for adapting the separation performance, the pressure loss and the volume flow in oil separation modules in crankcase ventilation are known. On the one hand, it is possible to connect various parallel-situated separation chambers discontinuously in order to make a sufficient separation performance constantly available as a function of the volume flow and the pressure loss. This however requires complex discontinuous connection of the flow chambers by means of push-pull systems or diaphragm spring systems. Alternatively, bypass openings around the oil separators can be provided, which are opened in the case of an increased volume flow or an increased pressure drop and, dispensing with oil separation, at least ensure crankcase ventilation. These can be actuated for example via a tappet-spring system. These systems require however in total a high cost expenditure and spatial requirement. Valve solutions are furthermore very susceptible to soiling.

The object of the present invention is therefore to make available an oil separator for oil and oil mist from a gas, such as for example a crankcase gas, in which an optimum separation performance is achieved in the normal case, however, even in the case of an increased volume flow or a blockage of the oil separators, crankcase ventilation and observance of a maximum pressure loss can be ensured at the same time. The present invention is intended to make available a constructionally simple and safe solution for this purpose.

This object is achieved by the oil separator according to claim 1. Advantageous developments of the oil separator according to the invention are given in the respective dependent claims.

The present invention deviates now from the concept of making available a separate bypass around the oil separator. It is rather provided here to dispose two oil separation elements in the volume flow one behind the other. These are designed such that, with a direct successive arrangement of the separation elements, an optimum separation performance is achieved with a defined pressure drop under the nominal volume flow in the operating characteristics. It is now provided according to the invention that one of the separation elements is displaceable in the axial direction of the gas flow relative to the other separation element. Since turbulences occur normally in the transition between the two separation elements, it is possible due to spacing of the two separation elements away from each other to reduce these turbulences and consequently to reduce the pressure loss across the oil separator. This then makes it possible also to handle higher volume flows with a limited pressure drop.

In a particularly advantageous form, the separation elements respectively contain spiral segments which, together with the wall of the separation elements, form spiral or helical gas flow paths. In each of the separation elements, a similar separation performance to a passive separator from the state of the art is thereby achieved already due to the centrifugal forces acting on the oil droplets.

If the spiral segments are disposed in opposite directions in successive separation elements then, during the transition from one direction of rotation of the gas into the other direction of rotation of the gas when flowing through the transition between the first separation element and the second separation element, an additional high oil separation performance is produced, since the spiral segments here act in addition as deflection separators. In this transition, very high turbulences occur and hence a high pressure loss which can be reduced due to moving apart of successive separation elements.

It can additionally be provided that gas, which enters into the intermediate space between these elements in the case of separation elements which have moved apart from each other, has an additional flow path around one of the separation elements. It can be brought about in this case that the gas flows merely for example through the first separation element and subsequently bypasses the second separation element. As a result, a further reduction in the pressure loss occurring and a further increase in the possible volume flow is made possible then in this further step. This concerns so to speak a partial bypass solution around one part of the separation stretch which is composed of the first separation element and the second separation element.

Furthermore, it is also possible to provide an opening for one of the separation elements in the carrier plate thereof, said opening being able to act as a bypass around this separation element. However it is then provided that, in normal operation, i.e. first and second separation elements situated closely beside each other, the thus produced bypass around one of the separation elements is closed. In normal operation, the total volume flow is therefore directed through the separation elements. When the separation elements are moved apart, the bypass can then be opened in one of the separation elements so that, on the one hand, the gas can also flow through this bypass and subsequently only through the second separation element or, in the other case, through the bypass directly to the suction side of the oil separator. In this case, which occurs in particular with a very high pressure drop and high volume flows, at least the crankcase ventilation is ensured dispensing with complete oil separation.

The displaceability of the one oil separation element relative to the other can be effected in that the one oil separation element is mounted via a resilient spring and is pressed by this spring against the other separation element. The spring is thereby designed such that, with a specific pressure which is exerted on the mounted separation element, the spring force is overcome due to an excessive pressure difference between the pressure and suction side of the oil separator and the separation element is removed from the other separation element.

Springs comprising bimetal or shape memory metal prove thereby to be particularly advantageous since these have the effect that the second separation element, upon cooling, is distanced from the first separation element and it is hence ensured that, even with freezing of the condensed water present in the oil separator, freezing together of the separation elements or the carriers thereof does not result.

A particularly simple solution resides in pressing the subsequent separation element against the preceding separation element by means of a resilient spring. If required, a pressure plate can also be disposed on the subsequent separation element in order to produce the counter-pressure against the spring.

Although in the present invention a first separation element and a second separation element which are one behind the other are mentioned, it is of course also possible to dispose a plurality of first separation elements in parallel in the flow course next to each other, a corresponding second separation element also being provided then for each of these parallel first separation elements. It is also possible to provide merely a plurality of first separation elements and to conduct the blowby gas which flows through the latter collected by a single second separation element. Also a plurality of second separation elements can be provided, amongst which the gas flow of a single first separation element is divided. In summary, one to several first separation elements can therefore be provided, and one to several second separation elements, the number of first separation elements and the number of second separation elements being able to be combined in any way.

Separation elements and spiral segments according to the invention are disclosed in particular in DE 10 2004 011 176.6 and in the associated unpublished patent specification which is herewith included in the present application with reference to all the variants disclosed there.

As a result of the solution according to the invention, a cost reduction, a complexity reduction and differentiation, relative to all the solutions present in the state of the art, of the problem of excessive volume flows and excessive pressure drops across oil separators is achieved. In particular, a blowby gas flow-dependent control of the pressure loss is achieved by the separator without any additional switching mimicry. It is in particular possible solely due to the dimensioning of the resilient spring and/or the pressure plate which acts against the resilient spring to have adaptation of the oil separator according to the invention to the most varied of engines, blowby volume flows, permissible pressure drops etc. The oil separators according to the invention can be incorporated in a space-saving manner in all module systems or component parts which conduct blowby gases. These are in particular oil pans and/or valve covers. Both elements should nowadays be configured to be as small and/or flat as possible. Nevertheless the present invention enables integration of oil- or oil mist separators in these module systems.

Some examples of oil separators according to the invention are now given in the following. The schematically illustrated examples are intended however merely by way of explanation. The invention is in no way restricted to them, this applies in particular for the number of separation elements. There are shown

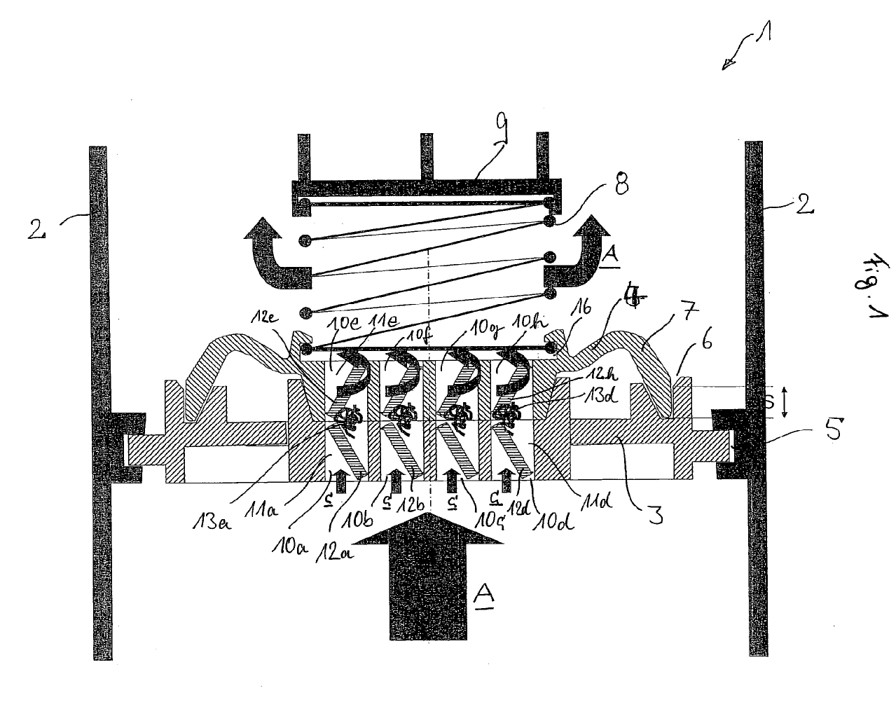

FIG. 1 a first oil separator according to the invention;

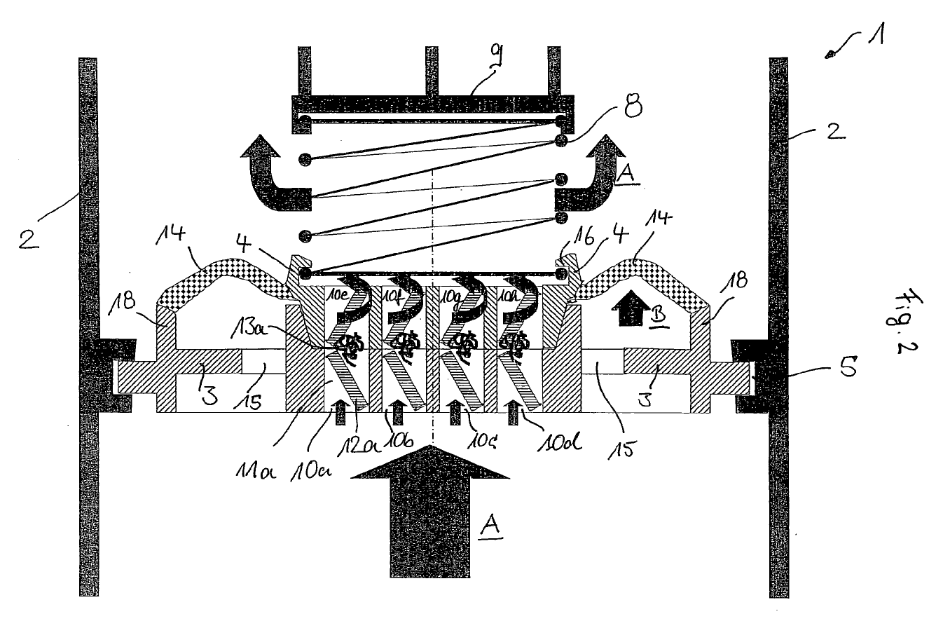

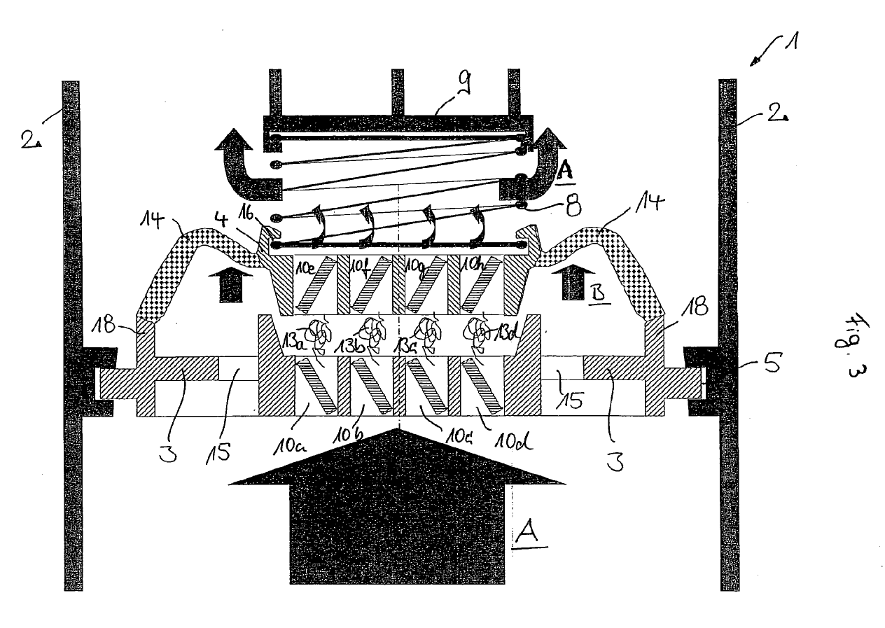

FIGS. 2 and 3 various states of a further oil separator according to the invention; and

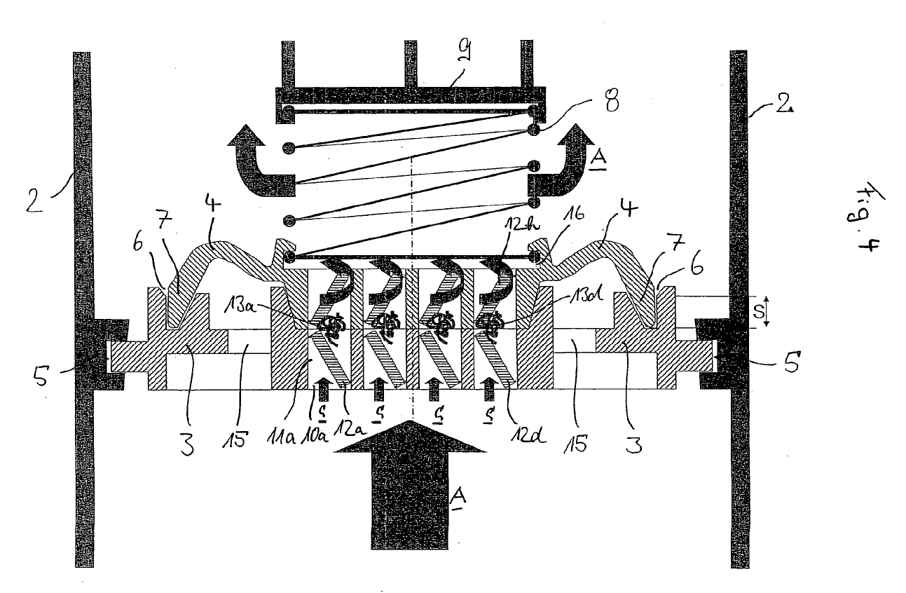

FIGS. 4 to 6 various states of a further oil separator according to the invention.

FIG. 1 shows an oil separator 1 according to the invention which has a passage 2 for conducting crankcase gases from the crankcase as pressure side into the inlet manifold of an engine as suction side of the oil separator 1. In this passage 2, a base plate 3 is mounted via a bearing 5, said base plate being constructed cylindrically symmetrical relative to the passage 2. In this base plate 3 which forms a seal with the passage 2, four separation elements 10a to 10d are disposed. These separation elements 10a to 10d are situated in the volume flow of the gas, which is designated by the arrows A, parallel to each other so that partial volume flows c flow through respectively one of the separation elements 10a to 10d. All these separation elements 10a to 10d have a throughflow pipe 11a to 11d in which one spiral segment 12a to 12d respectively is disposed. This spiral segment forms spiral flow paths for the blowby gas which rotate to the left. In the downward flow direction, a further base plate 4 is disposed on the base plate 3. This base plate 4 is mounted in a groove 6 of the base plate 3 via a circumferential engagement element (spring) 7. The wall of the groove 6 and of the spring 7 are configured such that, even upon displacement of the base plate 4 in the axial flow direction of the gas, the base plate 4 is guided relative to the base plate 3. The base plate 4 for its part has a bearing 16 for a spring 8 which is mounted on a mounting 9 by its other end. This resilient spring, for example a spiral spring made of spring steel, now presses the base plate 4 against the base plate 3.

The base plate 4 has in addition in total four second separation elements 10e to 10h which likewise have throughflow pipes 11e to 11h (not all the reference numbers are given for reasons of clarity), with spiral elements 12e to 12h inserted therein. One of these second separation elements 10e to 10h respectively is disposed in the flow direction after respectively one first separation element 10a to 10d so that the partial flow c flows respectively through a first separation element 10a to 10d and subsequently through a second separation element 10e to 10h. The spiral segments 12e to 12h are disposed in such a manner that their wall together with the wall of the flow pipes 11e to 11h sets the gas in rotation to the right. Correspondingly, during transition from a first separation element, here for example 10a, into a second separation element, here for example 10e, a very severe turbulence of the blowby gas occurs since the direction of rotation of the gas is reversed during this transition. This turbulence leads on the one hand to a pressure loss and, on the other hand, to a very good separation performance for oil or oil mist.

In the case of normal pressure loss across the separation elements from the pressure side to the suction side of the oil separator, the spring force of the resilient spring 8 is set such that it presses the base plate 4 against the base plate 3.

FIG. 2 shows a further variant of a separation element according to the invention which corresponds entirely to that in FIG. 1, with the exception that the edge regions of the base plate 4, in particular the region which extends between the separation elements 10e to 10h to the spring 7, is configured as a resilient diaphragm. This diaphragm 14 is now not mounted in a groove but fixed to form a seal on a flange 18 of the base plate 3.

Furthermore, individual openings 15 (for example individual borings) are provided in the base plate 3. In the normal state, as illustrated in FIG. 2, the base plate 4 is pressed entirely by the spring force of the resilient spring 8 against the base plate 3 so that no flow path for the blowby gas from the pressure side to the suction side is produced through the opening 15.

However a force which corresponds to the pressure drop across the oil separator and which counteracts the resilient spring 8 is exerted on the resilient diaphragm 14.

Here as in the following, identical or similar reference numbers are used for identical and similar elements. For reasons of clarity, not all the reference numbers were illustrated in this and in the following Figures. The omitted reference numbers can be derived respectively from FIG. 1.

FIG. 2 now shows the same state as in FIG. 1 and therefore requires no further explanation.

FIG. 3 now shows a state in which the pressure drop is increased, for example due to blockage of one of the separation elements 10a to 10h or due to an increased volume flow through these separation elements 10a to 10h. The force of the resilient spring 8 is set such that this is now overcome by the force acting on the diaphragm 14 and the base plate 4 is moved apart from the base plate 3 by the pressure occurring on the separation elements 10e to 10h. As a result of this moving apart, the turbulence zone between the separation elements 10a to 10d and the separation elements 10e to 10h is widened so that the turbulences 13a to 13d can be effected over a longer stretch and thus the pressure drop which occurs due to these turbulences 13a to 13d is reduced. Furthermore, a flow path is formed through the openings 15, the gap between the base plates 3 and 4 and the second separation elements 10e to 10h, which flow path bypasses the first separation elements 10a to 10h and hence has a lower pressure drop. The plate 4 is therefore moved apart from the plate 3 so far until the pressure drop across the operating face is reduced such that it now corresponds to the spring force of the resilient spring 8. As a result, it is therefore achieved that, with slightly reduced separation performance, the ventilation of the crankcase gas and the predetermined pressure loss are observed.

FIG. 4 now shows a further variant of an oil separator according to the invention which corresponds in practice entirely to the oil separator in FIG. 1. It is merely the case that individual openings 15 (for example individual borings) are provided in the base plate 3. In the normal state, as illustrated in FIG. 4, the base plate 4 is pressed entirely by the spring force of the resilient spring 8 against the base plate 3 and the spring 7 engages entirely in the groove 6.

In this case, closure of the opening 15 is also provided by the base plate 4 so that no blowby gas can flow through the opening.

In this case, the opening 15 merely makes it possible that the pressure prevailing on the pressure side on the oil separator acts on the circumferential edge of the base plate 4 between the separation elements 10e to 10h and the groove 7. This region of the base plate 4 serves therefore as pressure plate which produces the counter-force to the resilient spring 8.

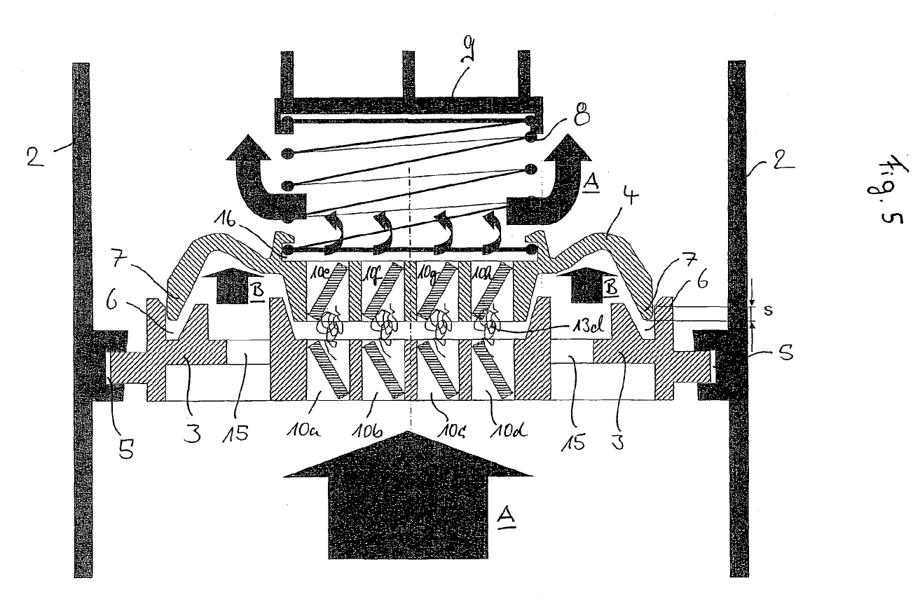

In FIG. 5, the case is shown in which the pressure drop is increased for example as a result of a slightly higher volume flow or slight soiling of the separation elements 10a to 10h. As a result, as shown in FIG. 3, the base plates 3 and 4 move apart from each other in opposition to the force of the spring 8. The corresponding action force is illustrated as arrow B in FIG. 5 relating to its effect. As a result, in turn the turbulence zone of the turbulences 13a to 13d is therefore increased so that the pressure loss is reduced. In this state, the spring 7 however continues to engage in the groove 6 to form a seal so that the blowby flow must flow at least entirely through the separation elements 10e to 10h.

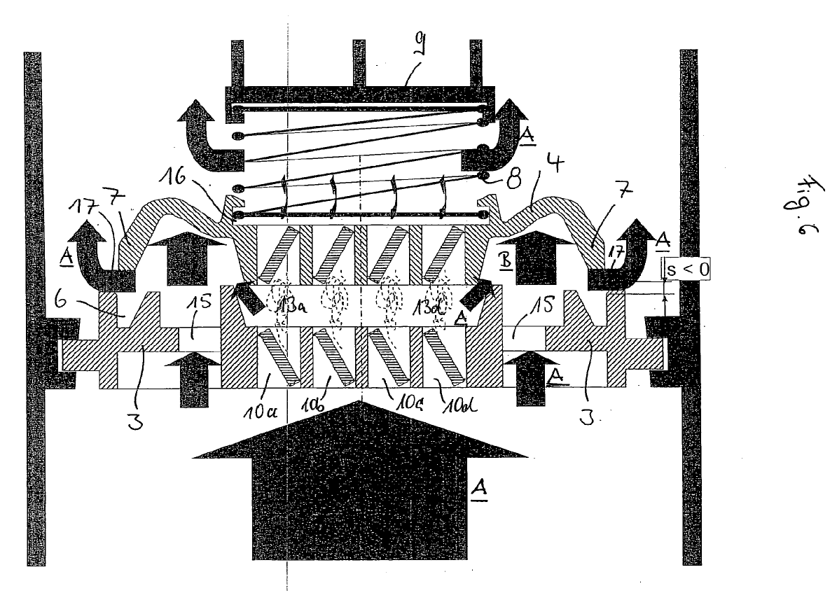

In FIG. 6, the case is now illustrated in which the pressure loss across the oil separator has become so high that the base plate 4 is at its furthest remove from the base plate 3. In this case, further flow paths are produced, through the first separation elements 10a to 10d evading the second separation elements 10e to 10h into the space situated in front of the pressure plate. The gas can also flow in here through the opening 15. The spring 7 is now removed so far from the groove 6 until an opening is produced at the outermost edge of the base plate 4 between the base plate 4 and the base plate 3, via which opening gas can flow to the suction side of the oil separator. In this case, only a small volume flow is therefore effected still through the first separation elements 10a to 10d, whilst the greatest part of the blowby gas flows through the opening 15 and the opening 17 from the pressure side to the suction side of the oil separator. With the loss of separation performance, it is consequently ensured that, even with very high volume flows or complete blockage of separation elements, ventilation of the crankcase is ensured with a defined pressure loss across the oil separator.

The control via the force of the resilient spring can thereby have switch-over points at which the transition between a base plate 4 which is pressed completely against the base plate 3 and a separated base plate 4 occurs. Also continuous control of the spacing between the base plate 3 and the base plate 4 is possible. As a result, the specific conditions of different engines can be catered for. In summary it can therefore be established that as a result of the present invention an optimum separation performance is ensured with a nominal blowby flow, whilst a constructionally simple, space-saving and reliable solution for the case of greatly excessive volume flows or blockages of the oil separator is made available at the same time.

1-24. (canceled)

25. An oil separator for separating oil and/or oil mist from a gas, having at least one first separation element and a second separation element which is disposed behind the first separation element in the axial throughflow direction, comprising a spacing changing device for varying the axial spacing between the first and the second separation element.

26. The oil separator according to the claim 25, wherein the spacing between the end, directed downstream, of the first separation element and the beginning, directed upstream, of the second separation element is variable due to the spacing changing device.

27. The oil separator according to claim 25, wherein the spacing changing device adjusts the spacing as a function of the pressure drop across the oil separator.

28. The oil separator according to claim 25, wherein the spacing changing device increases the spacing in the case of increasing pressure drop across the oil separator.

29. Oil separator according to claim 27, wherein the dependency of the spacing upon the pressure drop has a threshold value for switching between two spacing values or has a hysteresis.

30. The oil separator according to claim 25, wherein the spacing changing device has a resilient spring which presses the second separation element towards the first separation element with a predetermined force.

31. The oil separator according to claim 30, wherein the predetermined force is greater than the force exerted by a pressure drop on the second separation element in the predetermined operating characteristics of the oil separator but is smaller than a force exerted by a pressure drop in the case of an abnormally increased gas flow or a blockage of the oil separator.

32. The oil separator according to claim 25, wherein the oil separator has a gas-open passage from a pressure side to a suction side of the oil separator, from a pressure side of the first separation element to a pressure side of the second separation element and/or from a suction side of the first separation element to a suction side of the second separation element with low flow resistance and low or no separation effect for the oil or the oil mist, which passage is closed or open as a function of the spacing between the first and the second separation element.

33. The oil separator according to claim 32, wherein said passage is opened with a large spacing and closed with a small spacing.

34. The oil separator according to claim 25, wherein in a throughflow pipe, with an inlet for the gas and an outlet for the gas and possibly for the separated oil, which outlet is disposed gas-flow downstream of the throughflow pipe, there are disposed a first base plate which has at least the first separation element, and also a second base plate which has at least the second separation element, the first and the second separation elements together forming a flow path for the gas from the inlet to the outlet and the two base plates being displaceable relative to each other in the axial direction of the flow pipe.

35. The oil separator according to claim 34, wherein the second base plate is pressed by means of a resilient spring as part of the spacing changing device in the direction of the first base plate.

36. The oil separator according to claim 35, wherein the resilient spring comprises bimetal or shape memory material.

37. The oil separator according to claim 34, wherein at least one of the two base plates is disposed to form a seal on an inner circumferential edge of the flow pipe.

38. The oil separator according to claim 37, wherein the respectively other base plate is disposed to form a seal on said inner circumferential edge of the flow pipe.

39. The oil separator according to claim 34, wherein the two base plates are disposed to form a seal relative to each other.

40. The oil separator according to claim 39, wherein one of the two base plates has a groove which extends along a circumference thereof and the other base plate has a spring or web which engages at least in a closely adjacent state of the two base plates into this groove and extends along said circumference thereof.

41. The oil separator according to claim 40, wherein the spring is configured as a circumferential edge of a resilient diaphragm.

42. The oil separator according to claim 40, wherein the base plates can be spaced so far from each other that the groove and the spring are out of engagement.

43. The oil separator according to claim 34, wherein at least one of the two base plates has a passage opening the gas from a pressure side thereof to a suction side thereof which communicates, when the base plates are removed from each other, with a formed intermediate space between the first and the second separation element.

44. The oil separator according to claim 34, wherein at least one of the separation elements has a passage from a pressure side to a suction side in which a spiral segment is disposed, the threaded faces of which together with a wall of the passage form helical flow paths for the gas.

45. The oil separator according to claim 44, wherein at least one spiral segment respectively is disposed at least in the first and in the second separation elements, the spiral segments which are disposed in various separation elements disposed in the flow direction axially one behind the other have directions of rotation of the threaded faces and flow paths which are in opposite directions to each other.

46. The oil separator according to claim 25, wherein the separator separates oil or oil mist from crankcase gases of an internal combustion engine.

47. The oil separator according to claim 25, wherein the separator is used with component parts of an internal combustion engine, which guide crankcase gases or blowby gases, in a valve cover and/or an oil pan of an internal combustion engine.

48. The oil separator of claim 25, wherein the separator is located in a passage between an inlet and an outlet for crankcase gases or blowby gases of an internal combustion engine.
